(19) United States
(12) Patent Application Publication
(10) Pub. No.: US 2025/0299029 A1
(43) Pub. Date: Sep. 25, 2025

(54) METHOD, APPARATUS, DEVICE AND MEDIUM FOR QUANTIZING DATA

(71) Applicant: Beijing Zitiao Network Technology Co., Ltd., Beijing (CN)

(72) Inventors: Yi Guo, Beijing (CN); Fanliu Kong, Beijing (CN); Xiaoyang Li, Beijing (CN); Hui Li, Beijing (CN); Wei Chen, Beijing (CN); Jinping Cai, Beijing (CN); Yang Zhang, Beijing (CN); Shouda Liu, Beijing (CN)

(21) Appl. No.: 19/081,915

(22) Filed: Mar. 17, 2025

(30) Foreign Application Priority Data
Mar. 20, 2024 (CN) 202410323179.8

(51) Int. Cl. G06N 3/0495; G06F 17/16

(52) U.S. Cl. CPC G06N 3/0495; G06F 17/16

(57) ABSTRACT

Methods, apparatuses, devices, and media for quantizing data are provided. In a method, a plurality of first vectors is extracted from a matrix to be quantized. A plurality of objective functions respectively associated with the plurality of first vectors is created. The plurality of objective functions respectively comprises the plurality of first vectors, a plurality of second vectors respectively corresponding to the plurality of first vectors, and a mapping parameter for respectively mapping the plurality of second vectors to a plurality of third vectors. The plurality of second vectors and the mapping parameter are determined based on the plurality of objective functions. For a first vector in the plurality of first vectors, the mapping parameter enables a difference between a third vector corresponding to the first vector in the plurality of third vectors and the first vector to meet a predetermined condition.

### CROSS-REFERENCE

The present application claims priority to Chinese Patent Application No. 202410323179.8, filed on Mar. 20, 2024, and entitled “METHOD, APPARATUS, DEVICE AND MEDIUM FOR QUANTIZING DATA”, the entirety of which is incorporated herein by reference.

### FIELD

Example implementations of the present disclosure generally relate to data compression, and more particularly to methods, apparatuses, devices, and computer-readable storage media for quantizing data.

### BACKGROUND

The machine learning technique has been widely used in multiple application environments. The machine learning model involves a large number of parameters, which results in a large amount of resources being consumed in the inference phase. Various quantization techniques have been proposed for compressing machine learning models. For example, data in the machine learning model may be compressed from a higher number of bits to a lower number of bits while ensuring data precision. However, the compressed data precision of the existing quantization technical solution is not satisfactory, and it is expected to provide a more efficient data quantization mode.

### SUMMARY

In a first aspect of the present disclosure, a method for quantizing data is provided. In the method, a plurality of first vectors is extracted from a matrix to be quantized. A plurality of objective functions respectively associated with the plurality of first vectors is created. The plurality of objective functions respectively comprises the plurality of first vectors, a plurality of second vectors respectively corresponding to the plurality of first vectors, and a mapping parameter for respectively mapping the plurality of second vectors to a plurality of third vectors. A second data width corresponding to the plurality of second vectors is less than a first data width corresponding to the plurality of first vectors. The plurality of second vectors and the mapping parameter are determined based on the plurality of objective functions. For a first vector in the plurality of first vectors, the mapping parameter enables a difference between a third vector corresponding to the first vector in the plurality of third vectors and the first vector to meet a predetermined condition.

In a second aspect of the present disclosure, an apparatus for quantizing data is provided. The apparatus comprises: an extracting module, configured to extract a plurality of first vectors from a matrix to be quantized; a creating module, configured to create a plurality of objective functions respectively associated with the plurality of first vectors, the plurality of objective functions respectively comprising the plurality of first vectors, a plurality of second vectors respectively corresponding to the plurality of first vectors, and a mapping parameter for respectively mapping the plurality of second vectors to a plurality of third vectors, a second data width corresponding to the plurality of second vectors being less than a first data width corresponding to the plurality of first vectors; and a determining module, configured to determine the plurality of second vectors and the mapping parameter based on the plurality of objective functions, for a first vector in the plurality of first vectors, the mapping parameter enables a difference between a third vector corresponding to the first vector in the plurality of third vectors and the first vector to meet a predetermined condition.

In a third aspect of the present disclosure, an electronic device is provided. The electronic device comprises: at least one processing unit; and at least one memory coupled to the at least one processing unit and storing instructions for execution by the at least one processing unit, the instructions, when executed by the at least one processing unit, causing the electronic device to perform the method according to the first aspect of this disclosure.

In a fourth aspect of the present disclosure, a computer-readable storage medium is provided, having stored thereon a computer program which, when executed by a processor, causes the processor to implement the method according to the first aspect of this disclosure.

It should be understood that the content described in this section is not intended to limit key features or important features of implementations of the present disclosure, nor is it intended to limit the scope of the present disclosure. Other features of the present disclosure will become readily understood from the following description.

### BRIEF DESCRIPTION OF DRAWINGS

The above and other features, advantages, and aspects of the various implementations of the present disclosure will become more apparent from the following detailed description taken in conjunction with the accompanying drawings. In the drawings, the same or similar reference numbers refer to the same or similar elements, wherein:

FIG. 1 shows a block diagram of an application environment according to an example implementation of the present disclosure;

FIG. 2 shows a block diagram for quantizing data according to some implementations of the present disclosure;

FIG. 3 shows a block diagram of a machine learning model according to some implementations of the present disclosure;

FIG. 4 shows a block diagram of a quantization and inverse quantization process according to some implementations of the present disclosure;

FIG. 5 shows a flowchart of a method for quantizing data according to some implementations of the present disclosure;

FIG. 6 shows a block diagram of an apparatus for quantizing data according to some implementations of the present disclosure; and

FIG. 7 shows a block diagram of a device capable of implementing various implementations of the present disclosure.

### DETAILED DESCRIPTION

Implementations of the present disclosure will be described in more detail below with reference to the accompanying drawings. While certain implementations of the present disclosure are shown in the accompanying drawings, it should be understood that the present disclosure may be implemented in various forms and should not be construed as limited to the implementations set forth herein, but rather, these implementations are provided for a more thorough and complete understanding of the present disclosure. It should be understood that the drawings and implementations of the present disclosure are for illustrative purposes only and are not intended to limit the scope of the present disclosure.

In the description of implementations of the present disclosure, the terms “comprise” and similar terms should be understood as open terms that mean “comprise but is not limited to”. The term “based on” should be understood as “based at least in part on”. The terms “one implementation” or “the implementation” should be understood as “at least one implementation”. The term “some implementations” should be understood as “at least some implementations”. Other explicit and implicit definitions may also be included below. As used herein, the term “model” may represent an association relationship between various data. For example, the association relationship may be obtained based on various technical solutions currently known and/or to be developed in the future.

It may be understood that the data involved in the technical solution (including but not limited to the data itself, the acquisition or use of the data) should follow the requirements of the corresponding laws and regulations and related regulations.

It can be understood that, before the technical solutions disclosed in the embodiments of the present disclosure are used, the types of personal information related to the present disclosure, the usage scope, the usage scenario and the like should be notified to the user in an appropriate manner according to the relevant laws and regulations, and the authorization of the user should be obtained.

For example, in response to receiving an active request from a user, prompt is sent to the user to explicitly prompt the user that the requested operation will need to acquire and use the personal information of the user. Therefore, the user can autonomously select whether to provide personal information to software or hardware such as an electronic device, an application, a server or a storage medium for executing the operation of the technical solution of the present disclosure according to the prompt.

As an optional but non-limiting implementation, in response to receiving an active request from the user, prompt is set to the user may be, for example, in a pop-up window, in which the prompt may be presented in text. In addition, the pop-up window may further comprise a selection control for the user to select “agree” or “disagree” to provide personal information to the electronic device.

It may be understood that the foregoing process of notification and obtaining a user authorization is merely illustrative, and does not constitute a limitation on implementations of the present disclosure, and other manners of meeting related laws and regulations may also be applied to implementations of the present disclosure.

The term “in response to” as used herein means a state in which a respective event occurs or condition is satisfied. It will be appreciated that the timing of execution of a subsequent action performed in response to the event or condition is not necessarily strongly correlated with the time at which the event occurs or the condition holds. For example, in some cases, subsequent actions may be performed immediately when an event occurs or a condition holds; while in other cases, subsequent actions may be performed after a period of time elapses after an event occurs or a condition holds.

### Example Environment

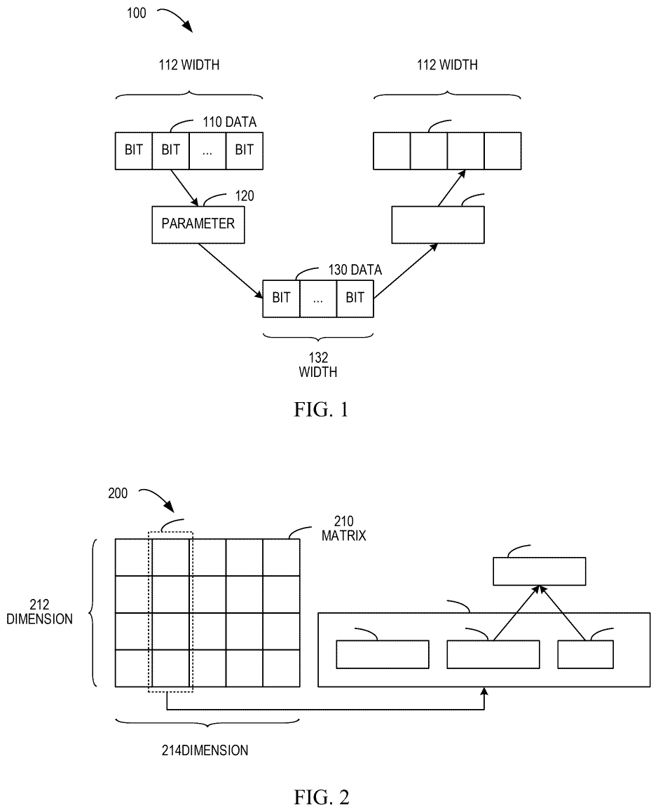

The machine learning technique has been widely used in multiple application environments. The machine learning model involves a large number of parameters, which results in a large amount of resources being consumed in the inference phase. Various quantization techniques for compressing a machine learning model have been proposed, for example, data in a machine learning model can be compressed from a higher number of bits to a lower number of bits while ensuring data precision. An application environment according to an example implementation of the present disclosure is described with reference to FIG. 1, which shows a block diagram of an application environment according to an example implementation of this disclosure.

As shown in FIG. 1, the data 110 may include a plurality of bits (e.g., a width of 112). In order to reduce the storage space occupied by the data 110, a quantization process may be performed by using the parameter 120, so as to convert the data 110 to the data 130 having the smaller width 132. Further, in an inverse quantization process, data 130 may be restored to data 150 by using the parameter 140. Here, parameters 120 and 140 may ensure that the difference between data 110 and 150 is not too large (e.g., satisfies a predetermined condition). Thus, the quantization and inverse quantization process may reduce the resource consumption involved in the data storage, transmission, and use while ensuring that the data precision is consistent with expectations.

With the gradual popularization of machine learning models, machine learning models have been applied to various industries. Machine learning models, especially large models, typically have a large number of parameters and involve huge amounts of computation that will consume a significant amount of resources during deployment and inference.

In the field of compression of machine learning models, a technical solution of post-training quantization (PTQ) has been proposed. PTQ does not require training of the model, but requires only a few samples as calibration. This makes quantization simple and feasible, speeding up the iterative cycle and reducing the complexity of downstream processing. Despite some success in the field of PTQ, it is difficult to achieve the desired precision in the case of very low bits (e.g., 2 bits, or 3 bits, etc.). The compression rate and/or the compressed data precision of the existing quantization technical solution are not satisfactory, so it is expected to provide a more effective data quantization mode.

### Summary of Data Quantization

In order to at least partially solve the deficiencies in the prior art, according to an example implementation of the present disclosure, a method for quantizing data is provided. For ease of description, a matrix is taken as a specific example in the context of this disclosure for describing more details of performing data quantization. Referring to FIG. 2, a summary is described according to an example implementation of the present disclosure, and FIG. 2 shows a block diagram 200 for quantizing data according to some implementations of the present disclosure.

As shown in FIG. 2, the matrix 210 to be quantized may have a first dimension (e.g., dimension 212) and a second dimension (e.g., dimension 214). The first dimension may, for example, represent a row in the matrix, and the second dimension may represent a column in the matrix. Alternatively and/or additionally, the first dimension may represent, for example, a column in the matrix, and the second dimension may represent a row in the matrix.

A plurality of first vectors may be extracted from the matrix 210 to be quantized. For ease of description, the first vector may represent each column in the matrix. Alternatively and/or additionally, in the case of exchanging the rows and columns in the matrix, the first vector may represent each row in the matrix. Further, a plurality of objective functions respectively associated with the plurality of first vectors may be created. Here, the plurality of objective functions respectively comprises a plurality of first vectors, a plurality of second vectors respectively corresponding to the plurality of first vectors, and a mapping parameter (for example, the parameter 232) for respectively mapping the plurality of second vectors to a plurality of third vectors.

Specifically, for the first vector 220, the objective function 222 may include a first vector 220, a second vector 230 corresponding to the first vector 220, and a parameter 232. Here, the parameter 232 may map the second vector 230 to the third vector 234. It should be understood that, since FIG. 2 relates to the quantization process, the second data width corresponding to the plurality of second vectors is smaller than the first data width corresponding to the plurality of first vectors. For example, the first data width may be, for example, 128 bits, 64 bits (or other values), and the second data width may be, for example, 32 bits, 16 bits, 8 bits, 4 bits, or even 2 bits.

It should be understood that although FIG. 2 only shows the objective function 222 corresponding to the first vector 220, each column vector in the matrix 210 may have a respective objective function, at which point there may be multiple objective functions. Further, the plurality of second vectors and the mapping parameter may be determined based on the plurality of objective functions. Specifically, the plurality of second vectors and the mapping parameter meeting the expectation may be found by solving the plurality of objective functions. In this case, for the first vector in the plurality of first vectors, the mapping parameter enables the difference between the third vector corresponding to the first vector in the plurality of third vectors and the first vector to meet the predetermined condition.

In other words, using the process shown in FIG. 2, the plurality of second vectors may be respectively restored to the plurality of third vectors having the higher width by using the mapping parameter, and the difference between the third vector and the corresponding first vector satisfies the predetermined condition. That is, the plurality of restored third vectors still have higher data precision and result in smaller errors. In this way, the data may be represented using a lower data width, and the precision of the quantization operation may be improved, thereby the accuracy of the machine learning model can be improved.

### Detailed Procedure for Data Quantization

Having described a summary according to one example implementation of the present disclosure, more details regarding data quantization will be described below. According to one example implementation of the present disclosure, the above-described matrix may be a weight matrix of the network layer in the machine learning model, the number of the first dimension of the matrix is determined by the width of input data of the network layer, and the number of the second dimension is determined by the width of output data of the network layer. With example implementations of the present disclosure, the weights of the machine learning model may be compressed in a more efficient manner, thereby reducing various resource overheads involved in the running of the machine learning model.

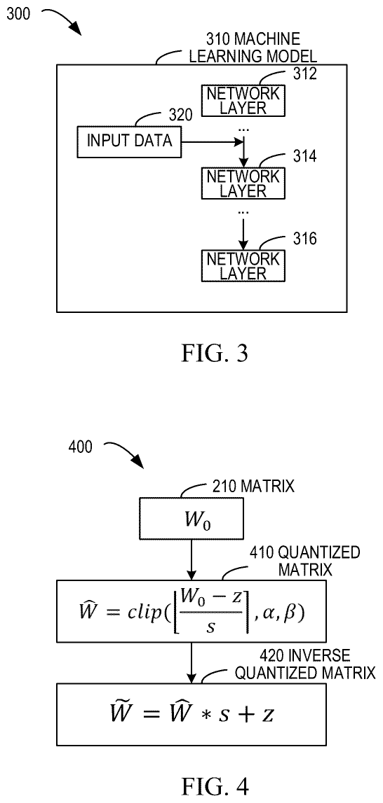

FIG. 3 illustrates a block diagram 300 of a machine learning model according to some implementations of the present disclosure. As shown in FIG. 3, the machine learning model 310 may comprise a plurality of network layers 312, . . . , 314, . . . , and 316. Here, each network layer may have a corresponding weight matrix, and the weight matrix of each network layer may be processed using the quantization process described above. Specifically, the initial weight matrix may be represented as W₀, and the dimension of the matrix may be represented by a width dᵢₙ of the input data and a width dₒᵤₜ of the output data. In this case, the dimension of W₀ is denoted as dᵢₙ×dₒᵤₜ, and W₀ϵ [symbol] ^{d}^{ᵢₙ}^{×d}^{ₒᵤₜ}. According to example implementations of the present disclosure, a corresponding quantization manner may be determined according to formats of input data and output data of different network layers. In this way, the quantization precision and the quantization efficiency of each network layer can be improved.

According to an example implementation of the present disclosure, the plurality of first vectors correspond to a floating point data space, and the plurality of second vectors correspond to an integer data space. With example implementations of the present disclosure, data originally represented in a floating point may be mapped to an integer data space, thereby reducing various resource overheads of the machine learning model through a quantization process.

According to one example implementation of the present disclosure, the mapping parameter may comprise a zero point parameter and a scaling parameter for mapping from the integer data space to the floating point data space. A complete quantization related process is described with reference to FIG. 4, which shows a block diagram 400 of a quantization and inverse quantization process in accordance with some implementations of the present disclosure. As shown in FIG. 4, the matrix 210 may be mapped to the quantized matrix 410 by a quantization operation. Specifically, the following equation may be used:

$$\hat{W} = clip ( ⌊ \frac{{W}_{0} - z}{s} ⌉ , α , β ) \qquad Equation 1$$

In the above equation, Ŵ represents a quantized matrix, clip( ) represents a truncation operation, α, β respectively represent a lower threshold and an upper threshold of the truncation operation, └ ┐ represents a rounding operation, W₀ represents an initial matrix, z represents a zero point parameter (that is, zero point) used to perform a mapping operation from the floating point data space to the integer data space, and s is a scaling parameter (that is, scale) for performing the mapping operation. The above equation may map the data in the floating point data space into the integer data space, and α, β respectively represents the minimum value and the maximum value represented by the integer data space.

Further, in the inverse quantization process, the quantized matrix 410 may be converted into an inverse quantized matrix 420. Specifically, the following equation may be used:

$$\tilde{W} = \hat{W} * s + z \qquad Equation 2$$

In the above equation, \tilde{W} represents an inverse quantized matrix, Ŵ represents a quantized matrix, z represents a zero point parameter (that is, zero point) used to perform a mapping operation from the integer data space to the floating point data space, and s is a scaling parameter (that is, scale) for performing the mapping operation. It should be understood that in the context of the present disclosure, the zero point parameter in Equation1 and Equation2 may be the same or different, and the scaling parameter in Equation1 1 and Equation1 2 may be the same or different.

It should be understood that, in order to ensure that the inverse quantized matrix can more accurately represent the initial matrix, the following condition shall be satisfied:

$$arg {min}_{\tilde{W}} {‖ X \tilde{W} - {XW}_{0} ‖}_{2}^{2} = tr \{ {( \tilde{W} - {W}_{0} )}^{T} H ( \tilde{W} - {W}_{0} ) \} \qquad Equation 3$$

In the foregoing equation, X represents data input into the network layer, W₀ represents a weight matrix of the network layer, \tilde{W} represents an inverse quantized weight matrix, and tr represents a trace of the matrix. A corresponding zero point parameter and a corresponding scaling parameter may be determined when the equation 3 is satisfied. In this way, it can be ensured that the error of the inverse quantized weight matrix is within an acceptable range.

According to one example implementation of the present disclosure, after the quantization of the model has been completed, only Ŵ [symbol] (s,z) of Equation 2 needs to be delivered when the model is delivered to the downstream processing procedure, and the downstream processing procedure needs not to know (s,z) of Equation 1. In this way, the (s,z) in Equations 1 and 2 may be decoupled. In this case, a corresponding objective function may be created for each column vector in the matrix, that is, the Equation 3 may be converted into the following:

$${min}_{w ; s , z} g ( w ; s , z ) \qquad Equation 4$$

$$s . t . ∀ i = 1 , 2 , … , {d}_{in}$$

$${w}_{i} - β \leq 0$$

$$- {w}_{i} + α \leq 0$$

$${w}_{i} ∈$$

In Equation 4, g(w;s,z) represents the objective function associated with each column vector, i.e., multiple objective functions may be created for ∀i=1, 2, . . . , dᵢₙ. According to an example implementation of the present disclosure, in the process of determining the objective function, the objective function may be generated based on the product of a transpose of the function component, the Hessian matrix and the function component. Specifically, the objective function may be determined using the following equation:

$$g ( w ; s , z ) = \frac{1}{2} {( w * s + z - b )}^{T} H ( w * s + z - b ) \qquad Equation 5$$

In the above equation, b represents the column vector (b∈ [symbol] ^{d}^{ᵢₙ}) in the W₀, w represents the quantized vector (i.e., the quantized vector respectively corresponding to each column vector, it may be represented as wᵢ, where i=1, 2, . . . , dᵢₙ). The mapping parameters s and z represent the scaling parameter and the zero point parameter respectively in the inverse quantization process. In this case, the function component of the objective function may be created by using the first vector, the second vector corresponding to the first vector in the plurality of second vectors, and the mapping parameter. In Equation 5, the function component may be represented, for example, as (w*s+z−b).

According to an example implementation of the present disclosure, the objective function may be determined by using the function component and the Hessian matrix of the input data (for example, represented as H). With example implementations of the present disclosure, each column vector may be processed separately, thereby reducing the amount of computation for the optimal solution of Equation 4, and enabling the determined optimal solution to further reduce the difference between the inverse quantized matrix and the original matrix. Specifically, the Hessian matrix may be expressed as: H=X^{T}X, where X represents input data of the network layer. With the example implementations of the present disclosure, the process of solving the optimal w,s,z may be converted into a mathematical calculation process, thereby improving the quantization precision with a predetermined data width.

According to an example implementation of the present disclosure, the equation 5 may be substituted into the equation 4, and the optimal resolution conforming to the equation 4 may be determined by using various ways currently known and/or developed in the future. With the example implementations of the present disclosure, it may not be necessary to concern the details of the existing quantization technical solutions. In other words, various detail problems, such as how to deal with outliers, how to process sensitive channels, etc., can be converted into the issue of determining the optimal solution that conforms to Equation 4. In this way, the precision of the quantization model may be greatly improved, that is, the theoretical upper limit of the precision of the quantization model, that is, the equation 3, can represent the precision of the model finally on a specific task.

According to one example implementation of the present disclosure, the integer data space has a lower threshold (e.g., represented as α) and an upper threshold (e.g., represented as β), wherein the lower threshold is lower than the zero value and the upper threshold is higher than the zero value. In other words, the integer data space crosses zero values. According to an example implementation of the present disclosure, the integer data space may be determined in a symmetric manner as possible, for example, a sum of a lower threshold and an upper threshold may satisfy a predetermined threshold.

According to an example implementation of the present disclosure, it is assumed that the second data width representing the integer data space is k, the lower threshold may be for example represented as −2^{k-1}, and the upper threshold may be for example represented as 2^{k-1}−1, and the sum of the lower threshold and the upper threshold is −1. Alternatively and/or additionally, the lower threshold may be for example represented as −2^{k-1}−1, and the upper threshold may be for example represented as 2^{k-1}, and the sum of the lower threshold and the upper threshold is −1.

According to an example implementation of the present disclosure, the proposed quantization technical solution enables the machine learning model to have acceptable precision in extremely low bit quantization operations. In particular, the second data width comprises at least one of the following: 2, 3, or 4. In other words, even if only 2 bits (3 bits, or 4 bits) are utilized to represent the model weight, the error caused by the inverse quantized weight data is still within an acceptable range relative to using the original weight data.

According to one example implementation of the present disclosure, a further weight matrix corresponding to the network layer may be generated using a plurality of third vectors, and data input to the network layer may be processed using the further weight matrix (e.g., represented as \acute{W}). Specifically, each determined vector wᵢ may be combined into a matrix Ŵ. Then, an inverse quantized weight matrix \tilde{W} is determined with the determined mapping parameter (s,z) and based on Equation 2. With example implementations of the present disclosure, an inverse quantized weight matrix may be obtained, and an error caused by an inverse quantized weight matrix obtained in this manner still meets an acceptable range.

Further, at each network layer of the machine learning model, the data processing task may be performed by using a corresponding weight matrix \tilde{W}. In this way, the precision of the quantization operation can be improved with a limited width to represent the weight matrix of the machine learning model, thereby improving the accuracy of the machine learning model.

### Example Processes

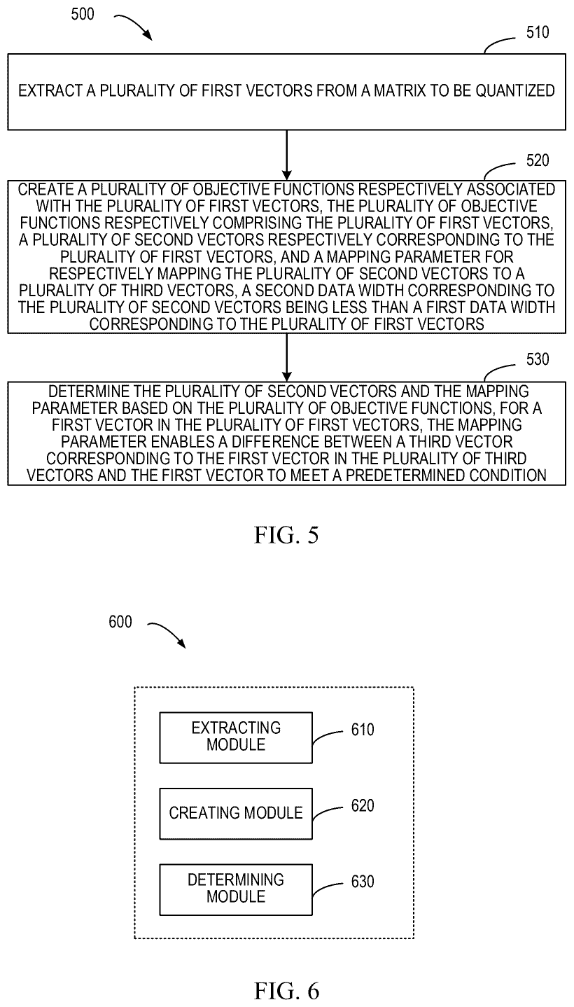

FIG. 5 shows a flowchart of a method 500 for quantizing data according to some implementations of the present disclosure. At block 510, a plurality of first vectors is extracted from the matrix to be quantized. At block 520, a plurality of objective functions respectively associated with a plurality of first vectors is created, where the plurality of objective functions respectively comprises the plurality of first vectors, a plurality of second vectors respectively corresponding to the plurality of first vectors, and a mapping parameter for respectively mapping the plurality of second vectors to a plurality of third vectors. A second data width corresponding to the plurality of second vectors is less than a first data width corresponding to the plurality of first vectors. At block 530, the plurality of second vectors and the mapping parameter are determined based on the plurality of objective functions. For a first vector in the plurality of first vectors, the mapping parameter enables a difference between a third vector corresponding to the first vector in the plurality of third vectors and the first vector to meet a predetermined condition.

According to an example implementation of present disclosure, the matrix is a weight matrix of a network layer in a machine learning model, the number of a first dimension of the matrix is determined by a width of input data of the network layer, and the number of a second dimension is determined by a width of output data of the network layer.

According to an example implementation of present disclosure, creating the plurality of objective functions comprises creating an objective function of the plurality of objective functions associated with the first vector based on: creating a function component of the objective function using the first vector, a second vector of the plurality of second vectors corresponding to the first vector, and the mapping parameter; and determining the objective function using the function component and a Hessian matrix of the input data.

According to an example implementation of present disclosure, determining the objective function comprises: generating the objective function based on a product of a transpose of the function component, the Hessian matrix and the function component.

According to an example implementation of present disclosure, the plurality of first vectors correspond to a floating point data space, the plurality of second vectors correspond to an integer data space, and the mapping parameter comprise: a zero point parameter and a scaling parameter for mapping from the integer data space to the floating point data space.

According to an example implementation of present disclosure, integer data space has a lower threshold and an upper threshold, and the lower threshold is lower than a zero value and the upper threshold is higher than a zero value.

According to an example implementation of present disclosure, a sum of the lower threshold and the upper threshold satisfies a predetermined threshold.

According to an example implementation of present disclosure, the method further comprises: generating a further weight matrix corresponding to the network layer using the plurality of third vectors; and processing data input to the network layer with the further weight matrix.

According to an example implementation of present disclosure, the second data width comprises at least one of: 2, 3, or 4.

According to an example implementation of present disclosure, the plurality of first vectors comprises a plurality of columns in the matrix.

### Example Apparatus and Device

FIG. 6 shows a block diagram of an apparatus 600 for quantizing data according to some implementations of the present disclosure. The apparatus 600 comprises: an extracting module 610, configured to extract a plurality of first vectors from a matrix to be quantized; a creating module 620, configured to create a plurality of objective functions respectively associated with the plurality of first vectors, the plurality of objective functions respectively comprising the plurality of first vectors, a plurality of second vectors respectively corresponding to the plurality of first vectors, and a mapping parameter for respectively mapping the plurality of second vectors to a plurality of third vectors, a second data width corresponding to the plurality of second vectors being less than a first data width corresponding to the plurality of first vectors; and a determining module 630, configured to determine the plurality of second vectors and the mapping parameter based on the plurality of objective functions, for a first vector in the plurality of first vectors, the mapping parameter enables a difference between a third vector corresponding to the first vector in the plurality of third vectors and the first vector to meet a predetermined condition.

According to an example implementation of present disclosure, the matrix is a weight matrix of a network layer in a machine learning model, the number of a first dimension of the matrix is determined by a width of input data of the network layer, and the number of a second dimension is determined by a width of output data of the network layer.

According to an example implementation of present disclosure, creating the plurality of objective functions comprises creating an objective function of the plurality of objective functions associated with the first vector based on: creating a function component of the objective function using the first vector, a second vector of the plurality of second vectors corresponding to the first vector, and the mapping parameter; and determining the objective function using the function component and a Hessian matrix of the input data.

According to an example implementation of present disclosure, an objective function determining module comprises: a generating module, configured to generate the objective function based on a product of a transpose of the function component, the Hessian matrix and the function component.

According to an example implementation of present disclosure, the plurality of first vectors correspond to a floating point data space, the plurality of second vectors correspond to an integer data space, and the mapping parameter comprise: a zero point parameter and a scaling parameter for mapping from the integer data space to the floating point data space.

According to an example implementation of present disclosure, integer data space has a lower threshold and an upper threshold, and the lower threshold is lower than a zero value and the upper threshold is higher than a zero value.

According to an example implementation of present disclosure, a sum of the lower threshold and the upper threshold satisfies a predetermined threshold.

According to an example implementation of present disclosure, the module further comprises: a matrix generating module, configured to generate a further weight matrix corresponding to the network layer using the plurality of third vectors; and a processing module, configured to process data input to the network layer with the further weight matrix.

According to an example implementation of present disclosure, the second data width comprises at least one of: 2, 3, or 4.

According to an example implementation of present disclosure, the plurality of first vectors comprises a plurality of columns in the matrix.

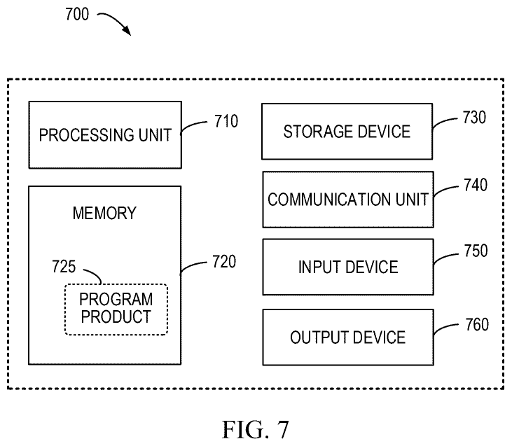

FIG. 7 illustrates a block diagram of a device 700 capable of implementing various implementations of the present disclosure. It should be understood that the computing device 700 shown in FIG. 7 is merely an example and should not constitute any limitation on the functionality and scope of the implementations described herein. The computing device 700 shown in FIG. 7 may be configured to implement the method described above.

As shown in FIG. 7, the computing device 700 is in the form of a general-purpose computing device. Components of the computing device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In multiprocessor systems, multiple processing units execute computer-executable instructions in parallel to improve parallel processing capabilities of computing device 700.

The computing device 700 typically comprises a plurality of computer storage media. Such media may be any available media accessible by the computing device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium, such as a flash drive, magnetic disk, or any other medium, which may be capable of storing information and/or data (e.g., training data for training) and may be accessed within computing device 700.

The computing device 700 may further comprise additional removable/non-removable, volatile/non-volatile storage media. Although not shown in FIG. 7, a disk drive for reading or writing from or to a removable, nonvolatile magnetic disk (e.g., a “floppy disk”) and an optical disk drive for reading or writing from or to a removable, nonvolatile optical disk may be provided. In these cases, each drive may be connected to a bus (not shown) by one or more data media interfaces. The memory 720 may include a computer program product 725 having one or more program modules configured to perform various methods or actions of various implementations of the present disclosure.

The communications unit 740 implements communications with other computing devices over a communications medium. Additionally, the functionality of components of the computing device 700 may be implemented in a single computing cluster or multiple computing machines capable of communicating over a communication connection. Thus, the computing device 700 may operate in a networked environment using logical connections with one or more other servers, network personal computers (PCs), or another network node.

The input device 750 may be one or more input devices such as a mouse, a keyboard, a trackball, or the like. The output device 760 may be one or more output devices, such as a display, a speaker, a printer, or the like. The computing device 700 may also communicate with one or more external devices (not shown) as needed, external devices such as storage devices, display devices, etc., communicate with one or more devices that enable a user to interact with computing device 700, or communicate with any device (e.g., network card, modem, etc.) that enables computing device 700 to communicate with one or more other computing devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above. According to example implementations of the present disclosure, there is provided a computer program product having stored thereon a computer program which, when executed by a processor, implements the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the one or more blocks in flowchart and/or block diagram.

The computer-readable program instructions may be loaded onto a computer, other programmable data processing apparatus, or other device, such that a series of operational steps are performed on a computer, other programmable data processing apparatus, or other device to produce a computer-implemented process, to enable the instructions executed on a computer, other programmable data processing apparatus, or other device to implement the functions/acts specified in one or more blocks in the flowchart and/or block diagram block.

The flowchart and block diagrams in the drawings show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagram and/or flowchart, as well as combinations of blocks in the block diagram and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A method for quantizing data, comprising:
extracting a plurality of first vectors from a matrix to be quantized;
creating a plurality of objective functions respectively associated with the plurality of first vectors, the plurality of objective functions respectively comprising the plurality of first vectors, a plurality of second vectors respectively corresponding to the plurality of first vectors, and a mapping parameter for respectively mapping the plurality of second vectors to a plurality of third vectors, a second data width corresponding to the plurality of second vectors being less than a first data width corresponding to the plurality of first vectors; and
determining the plurality of second vectors and the mapping parameter based on the plurality of objective functions, for a first vector in the plurality of first vectors, the mapping parameter enabling a difference between a third vector corresponding to the first vector in the plurality of third vectors and the first vector to meet a predetermined condition.

2. The method of claim 1, wherein the matrix is a weight matrix of a network layer in a machine learning model, the number of a first dimension of the matrix is determined by a width of input data of the network layer, and the number of a second dimension is determined by a width of output data of the network layer.

3. The method of claim 2, wherein creating the plurality of objective functions comprises creating an objective function of the plurality of objective functions associated with the first vector based on:
creating a function component of the objective function using the first vector, a second vector of the plurality of second vectors corresponding to the first vector, and the mapping parameter; and
determining the objective function using the function component and a Hessian matrix of the input data.

4. The method of claim 3, wherein determining the objective function comprises: generating the objective function based on a product of a transpose of the function component, the Hessian matrix and the function component.

5. The method of claim 1, wherein the plurality of first vectors correspond to a floating point data space, the plurality of second vectors correspond to an integer data space, and the mapping parameter comprise: a zero point parameter and a scaling parameter for mapping from the integer data space to the floating point data space.

6. The method of claim 5, wherein the integer data space has a lower threshold and an upper threshold, and the lower threshold is lower than a zero value and the upper threshold is higher than a zero value.

7. The method of claim 6, wherein a sum of the lower threshold and the upper threshold satisfies a predetermined threshold.

8. The method of claim 2, further comprising:
generating a further weight matrix corresponding to the network layer using the plurality of third vectors; and
processing data input to the network layer with the further weight matrix.

9. The method of claim 1, wherein the second data width comprises at least one of: 2, 3, or 4.

10. The method of claim 1, wherein the plurality of first vectors comprises a plurality of columns in the matrix.

11. An electronic device, comprising:
at least one processing unit; and
at least one memory coupled to the at least one processing unit and storing instructions for execution by the at least one processing unit, the instructions, when executed by the at least one processing unit, causing the electronic device to perform acts comprising:
extracting a plurality of first vectors from a matrix to be quantized;
creating a plurality of objective functions respectively associated with the plurality of first vectors, the plurality of objective functions respectively comprising the plurality of first vectors, a plurality of second vectors respectively corresponding to the plurality of first vectors, and a mapping parameter for respectively mapping the plurality of second vectors to a plurality of third vectors, a second data width corresponding to the plurality of second vectors being less than a first data width corresponding to the plurality of first vectors; and
determining the plurality of second vectors and the mapping parameter based on the plurality of objective functions, for a first vector in the plurality of first vectors, the mapping parameter enabling a difference between a third vector corresponding to the first vector in the plurality of third vectors and the first vector to meet a predetermined condition.

12. The electronic device of claim 11, wherein the matrix is a weight matrix of a network layer in a machine learning model, the number of a first dimension of the matrix is determined by a width of input data of the network layer, and the number of a second dimension is determined by a width of output data of the network layer.

13. The electronic device of claim 12, wherein creating the plurality of objective functions comprises creating an objective function of the plurality of objective functions associated with the first vector based on:
creating a function component of the objective function using the first vector, a second vector of the plurality of second vectors corresponding to the first vector, and the mapping parameter; and
determining the objective function using the function component and a Hessian matrix of the input data.

14. The electronic device of claim 13, wherein determining the objective function comprises: generating the objective function based on a product of a transpose of the function component, the Hessian matrix and the function component.

15. The electronic device of claim 11, wherein the plurality of first vectors correspond to a floating point data space, the plurality of second vectors correspond to an integer data space, and the mapping parameter comprise: a zero point parameter and a scaling parameter for mapping from the integer data space to the floating point data space.

16. The electronic device of claim 15, wherein the integer data space has a lower threshold and an upper threshold, and the lower threshold is lower than a zero value and the upper threshold is higher than a zero value.

17. The electronic device of claim 16, wherein a sum of the lower threshold and the upper threshold satisfies a predetermined threshold.

18. The electronic device of claim 12, further comprising:
generating a further weight matrix corresponding to the network layer using the plurality of third vectors; and
processing data input to the network layer with the further weight matrix.

19. The electronic device of claim 11, wherein the second data width comprises at least one of: 2, 3, or 4.

20. A non-transitory computer-readable storage medium having stored thereon a computer program which, when executed by a processor, causes the processor to implement a method comprising:
extracting a plurality of first vectors from a matrix to be quantized;
creating a plurality of objective functions respectively associated with the plurality of first vectors, the plurality of objective functions respectively comprising the plurality of first vectors, a plurality of second vectors respectively corresponding to the plurality of first vectors, and a mapping parameter for respectively mapping the plurality of second vectors to a plurality of third vectors, a second data width corresponding to the plurality of second vectors being less than a first data width corresponding to the plurality of first vectors; and
determining the plurality of second vectors and the mapping parameter based on the plurality of objective functions, for a first vector in the plurality of first vectors, the mapping parameter enabling a difference between a third vector corresponding to the first vector in the plurality of third vectors and the first vector to meet a predetermined condition.
